(19) United States
(12) Patent Application Publication
(10) Pub. No.: US 2014/0149513 A1
(43) Pub. Date: May 29, 2014

(54) SYSTEM AND METHOD FOR MATCHING A PROFILE TO A SPARSELY DEFINED REQUEST

(71) Applicant: The Extraordinaries, Inc., San Francisco, CA (US)

(72) Inventors: Patrick Grennan, San Francisco, CA (US); Ben Rigby, San Francisco, CA (US); Mark Nelson, Oakland, CA (US); Jordan Snodgrass, San Diego, CA (US)

(73) Assignee: The Extraordinaries, Inc., San Francisco, CA (US)

(21) Appl. No.: 14/089,196

(22) Filed: Nov. 25, 2013

Related U.S. Application Data
(60) Provisional application No. 61/729,534, filed on Nov. 23, 2012.

(51) Int. Cl. H04L 29/08

(52) U.S. Cl. CPC H04L 67/22
USPC 709/204

(57) ABSTRACT

A method and system that can include providing a request matching service within a community, receiving a request to match a task request with a first profile of the community, calculating a set of multi-layered composite similarity scores, selecting at least one matched task request according to composite scores, and outputting at least one matched task request of the first profile.

### CROSS-REFERENCE TO RELATED APPLICATIONS

This application claims the benefit of U.S. Provisional Application No. 61/729,534, filed 23-NOV.-2013, titled “SYSTEM AND METHOD FOR MATCHING A PROFILE TO A SPARSELY DEFINED REQUEST”, which is incorporated in its entirety by this reference.

### TECHNICAL FIELD

This invention relates generally to the recommendation engine field, and more specifically to a new and useful system and method for matching a profile to a sparsely defined request in the recommendation engine field.

### BACKGROUND

Recommendation engines have enabled improvements to many new services. Content recommendation such as movie and music recommendation benefits from various recommendation algorithms that factor in historical patterns for consumers of content and the content. Book, movie, music and similar recommendation systems have an ever-increasing amount of data that can be beneficial in refining the recommendation algorithm. Some situations, however, include elements with little or no historical information. For example, recommending a task for a new user inherently lacks historical data of the task on which to base a recommendation, and matching a task to a user with sparse historical data is a difficult task. Thus, there is a need in the recommendation engine field to create a new and useful system and method for matching a profile to a sparsely defined request. This invention provides such a new and useful system and method.

### BRIEF DESCRIPTION OF THE FIGURES

FIGS. 1 and 2 are schematic representations of a system of a preferred embodiment of the invention;

FIG. 3 is a flowchart representation of a method of a preferred embodiment of the invention;

FIG. 4 is a schematic representation of a method using profile and task sub-scores;

FIG. 5 is a schematic representation of variation of a method using CBCF models;

FIG. 6 is a detailed flowchart representation of providing a request matching service;

FIGS. 7 and 8 are exemplary breakdowns of a vectorized task and profile according to a feature set;

FIG. 9 is a detailed flowchart representation of providing a request matching service;

FIG. 10 is a schematic representation of a profile similarity score comparison;

FIG. 11 is a schematic representation of a task similarity score comparison;

FIG. 12 is a schematic representation of different layers used in profile and task CBCF sub-scores;

FIG. 13 is a schematic representation of a direct similarity score;

FIG. 14 is a graph representation of a change in weight profiles according to the age of a community;

FIG. 15 is a detailed flowchart representation of providing a CBCF request matching service;

FIG. 16 is a schematic representation of supplementing a first community with matching resources of a second community; and

FIG. 17 is a flowchart representation of an exemplary implementation of a method of a preferred embodiment of the invention.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. System for Matching a Profile to a Sparsely Defined Request

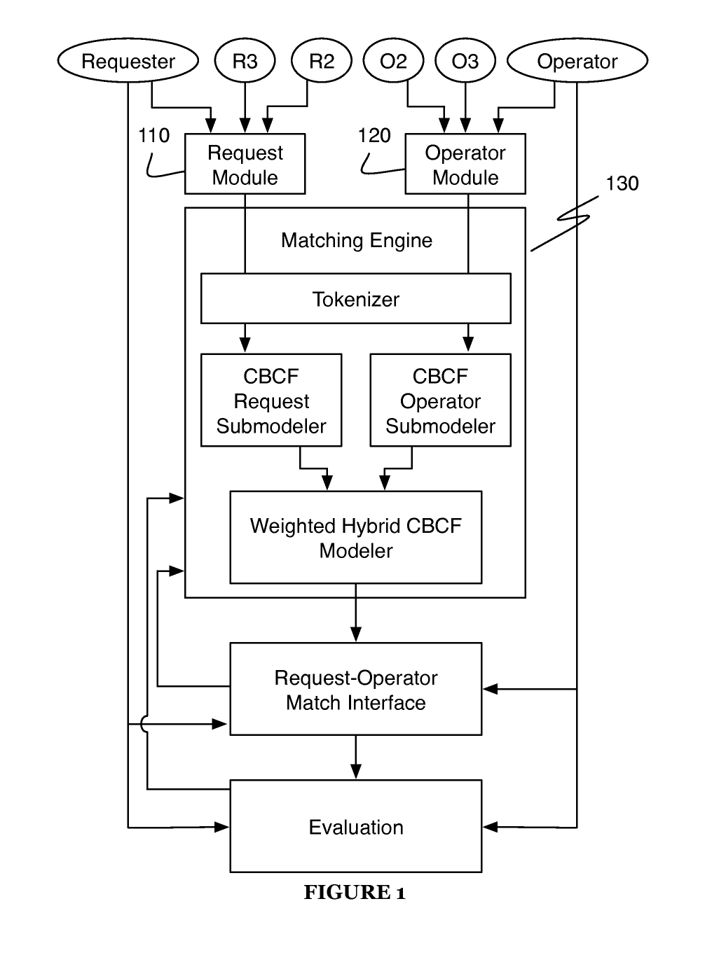

As shown in FIG. 1, a system for matching a profile to a sparsely defined request of a preferred embodiment may include a request module 110, an operator module 120, and a matching engine 130. In one preferred embodiment, the system is implemented to create a task-to-worker matching system of at least one community. The system preferably enables requests to be crowd-sourced to internal and/or external communities. The system is particularly suitable for matching task requests (e.g., “request for proposal”, “request for bid” or “request for expertise”) with appropriately interested and skilled operators that can complete the task. A task can be any suitable request that requires action by at least one operator. The task can be a question, a problem statement, a project/job requiring completion or action, a series of tasks, or any suitable item that can benefit through matching with an operator. In one variation, the system may be used by non-profit organizations to identify interested and skilled volunteers to complete tasks for the non-profit. In another variation, a company may deploy the system to leverage large communities of highly skilled and diverse employees to solve problems within a company. As another variation, the system may be used for identifying vendors with the appropriate skills, products, or services to bid on a proposal (request). The system can be used to optimize the personal reward a user receives from completing or fulfilling a request while also maximizing the competency with which the task is completed. The system preferably achieves such a goal by optimizing an objective function of how likely a potential interaction between two items of disparate types is to result in a certain type of interaction (e.g., the user completes a task request or the user does not perform the task). The system is preferably used in matching scenarios where historical data on the matched items can be sparse or non-existent. In the case of task requests, a task may become irrelevant, expired, completed, or otherwise not considered for matching to a profile. In contrast to product recommendation, where the product can acquire considerable historical data on target profiles, a task request can be transitory or short lived.

In alternative embodiments, the system may be applied to matching items of any suitable type. In alternative embodiments, the recommended item (e.g., the request) may alternatively be a daily article, book, movie, music, store, event, product, profile, and/or any suitable item. The receiver of the recommendation (e.g., the profile) may be any suitable item such as an employee, volunteer, business, similar product, location, and/or any suitable receiver of a recommendation. Typically the recommended item and the receiver of the recommendation are items of at least two different types, but may alternatively be of the same type. Hereafter, the embodiment of recommending requests to a profile will be used, but the invention is not to be limited to such items. The system is particularly designed for addressing matching content (e.g., tasks and people to perform the task) that is sparsely defined. Herein, sparsely defined describes content that has little information of previous interactions. In the case of requests, a request is typically an independent discrete element, which may have little or no historical data at the time of a recommendation. Similarly, a new operator profile may have little or no data to use in recommending tasks. The system preferably uses content boosted collaborative filtering (CBCF) processes of the matching engine 130 to enable a new request to be matched to an operator. As described below, the matching engine 130 preferably leverages a multi-layered sub-scoring model to accommodate lack of information. The system is preferably implemented on a distributed computing infrastructure, and the matching engine is preferably configured to decompose processes in a manner that is scalable and efficient in a distributed computing environment.

The request module no functions to generate a request. The request preferably specifies a task, unit of work, and/or desired action from an operator. The request may alternatively be any suitable desired object or result. The requests are preferably independent, distinct, and unique from other requests. Requests can include a notion of expiration and may cease to become relevant after a particular time, after completion, after any suitable interaction condition, and requests may not experience many interactions. An interaction can include any suitable action a profile can have on a request. There can additionally be multiple types or levels of interactions. An interaction can include completing or responding according to the goal of the request (e.g., submitting an image, document, or media file), commenting or providing feedback to the request or submission of another profile, sharing or distributing the request (e.g., sharing on a social network), bookmarking or favoriting a request, rating a request, and/or performing any suitable interaction. Thus, requests may not have substantial historical data. The request is preferably a data entity. The data entity preferably includes the field parameters of a request description, description of the requester (i.e., who is making the request), description of corresponding skills to complete the request, and causes or reasons of the request. The data entity may additionally or alternatively include any suitable alternative field parameters such as a title description, a geographic location, a category label, topic tags, and/or any suitable description of the request. The type of field parameters can additionally include any suitable form type such as text field, selection options, multiple-choice options, rating measure, media attachment, and/or any suitable field type. The request module 110 may include a user interface for collection and creation of the request data entity. The interface of the request module 110 preferably includes a requester to enter at least one field parameter of the request data entity and submit the request for fulfillment by an operator. The request module no may additionally include a request fulfillment review module. A requester can review and rate responses to the request that have been submitted by an operator in the request fulfillment review module.

The operator module 120 functions to deliver requests to a user to fulfill a request. The operator module 120 preferably facilitates a user submitting information and identifying appropriate requests to complete. The operator module 120 preferably includes a plurality of operator profiles. An operator profile preferably includes field parameters that describe a user. The profile field parameters may include fields of interest, fields of expertise, personal summary, past jobs, geographic location, and/or any suitable information. As with the field parameters of the request module no, the profile field parameters can include various field types. A user will preferably generate a profile upon creating an account. The profile can be manually entered by a user, but the profile may alternatively be constructed from an outside source such as an outside social network identity, such as one used to authenticate with the community. Additionally, the operator module 120 preferably includes an interface for browsing matched requests, and an interface for submitting any responses (e.g., a completed work).

The matching engine 130 functions to identify algorithmically selected request-operator matches. The matching engine 130 preferably employs machine learning algorithms on request data entities and operator profiles to find preferred matches. The matching engine 130 preferably uses similarity comparison algorithms to identify a match of at least one profile and at least one request. In a preferred implementation, a query is made to identify a request for a first profile. For example, when a user searches for appropriate requests, a series of task requests can be presented to the user where the task requests were selected based on a score predicting the task as a suitable mask. As an alternative implementation, at least one profile can be selected for a given task.

The matching engine 130 can use a combination of similarity scores that preferably include at least a task similarity score and a profile similarity score. In the preferred implementation, each type of sub-score is calculated for a considered task request. A task similarity score is a measure of similarity of the task in question with the set of tasks requests that a profile has interacted with (i.e., completed some form of interaction). A profile similarity score is a measure of similarity of the first profile compared to the profiles that completed the task in question. The sub-scores can include multiple task similarity scores for different task information fields, and can similarly include multiple profile similarity scores for different profile fields. For example, each considered task request can have a task similarity score for the description field, a task similarity score for a tag field, a profile similarity score for a skill set field, and a profile similarity score for an interest field. Additionally, another sub-score can include a direct similarity score that is a measure of similarity of the profile to a task. The similarity score can be described as a direct similarity comparison and can be based on fuzzy search matching and other suitable similarity heuristics for comparing two documents. The sub-scores are used in combination to create a composite score. The composite score is preferably a weighted combination of the sub-scores. Further, the matching engine 130 can apply normalization and other considerations into the generation of a composite score.

While, the similarity scores can be any suitable similarity calculation of the fields, the matching engine 130 is preferably configured to perform content-boosted, collaborative filtering (CBCF) which functions to use content information about the profile and the request. As the request information and a new operator profile may be defined by sparse data (e.g., little or no historical data), CBCF processes can be used to leverage content directly known about the request and/or profile. A hybrid model is preferably used, as discussed above, taking into account at least two CBCF sub-models of requests and operator profiles respectively for the considered tasks in the community. The operator-based profile CBCF sub-model preferably predicts a rating using content-based similarities between operator profiles, and the request-based CBCF sub-model preferably predicts a rating using content-based similarities between requests. A third weighted CBCF model takes into account both the operator-based and request-based sub-models. The matching engine 130 may additionally include a tokenizer used in vectorizing requests and operator profiles. The matching engine preferably uses the vectorized requests and operator profiles in calculating a cosine distance comparison of two items of the same type (request or profile). A benefit of the particular machine learning algorithm is that the process on the platform may parallelize computation across an arbitrarily high number of cores (e.g., 10-500) and store the dataset, intermediate results, and calculations (e.g., similarity measures and vector representations) in a database for fast, indexed distributed access. Alternative and/or additional machine learning processes may be used.

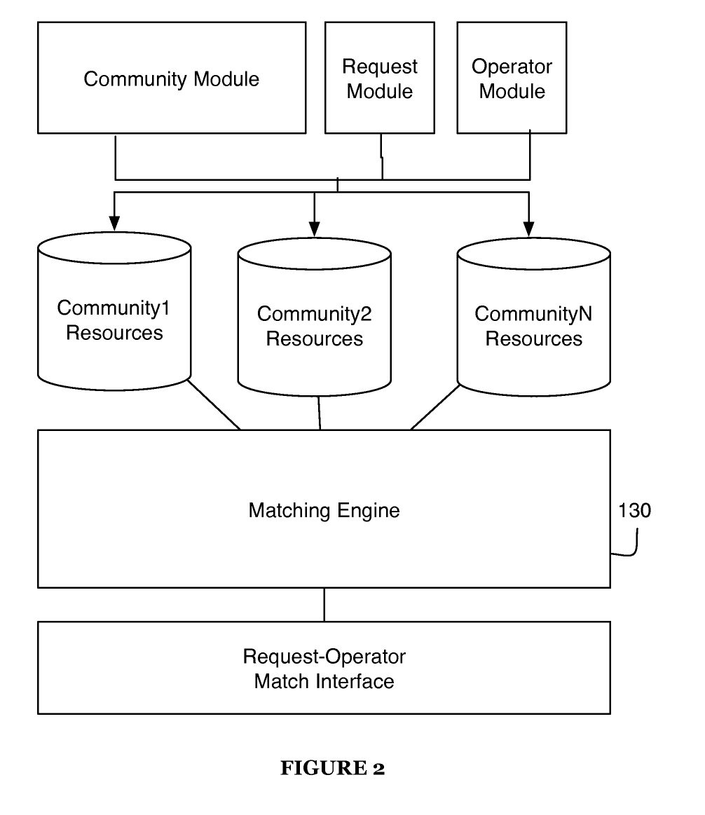

As shown in FIG. 2, the system can additionally include a community module 140, which functions to facilitate a community manager/administrator from creating, modifying, and/or managing one or more communities. The system includes mechanism that function to facilitate customization of matching performance, on-boarding, and customization of matching. The sub-models create a dynamic matching system that accommodates for sparse information about tasks or profiles. The system can additionally be used in collaborative development of related communities. The system can be used to spawn or develop sub-class communities (e.g., communities that inherit from a parent community), merge two previously un-related communities, fork/branch/duplicate a community. While many communities such as social networks, review sites, and other long term non-sparse matching applications rely on large amount of data within the community, the system can leverage knowledge of other communities.

The tokenizer is used to vectorize fields of a request. The tokenizer also facilitates generation of a feature set that can be used in calculation of similarity scores that then contribute to the calculation of sub-scores. A feature set can be static or continuously updated. Additionally, feature sets of a second community can be coupled to a first community. The borrowing or coupling of an outside communities feature set can be used to supplement or augment the calculation of a similarity scores. When first starting a new community, the feature sets of the new community will be sparse or possibly non-existent—a feature set of an outside community can be used to supplement the feature set until the new community has sufficiently built up a feature set.

Similarly, a community can have customized composite score weights, which can be used in calculating a composite score from sub-scores. The weights can be a set of weights that are used in a function that calculates a composite score using the sub-scores. The weights can be manually set or more preferably algorithmically learned. In one implementation, the weights are learned through an offline-learning algorithm. The weights can have dynamic sequence that can be tied to duration of the community, number of interactions within the community, growth of the community and/or other properties indicating maturation of the community. The system can include an offline learning algorithm routine for learning/modifying weights with the growth of the community. The weight sequences of a community can additionally be applied to other communities. As another addition weight configuration may be adjusted through the community module 140. The community module 140 can include community matching preferences. Based on the setting of the weights, the community can supply matches that emphasize quality completion of a task, speed of completion of a task, user fulfillment of completing a task, or any suitable property of a match.

### 2. Method for Matching a Profile to a Sparsely Defined Request

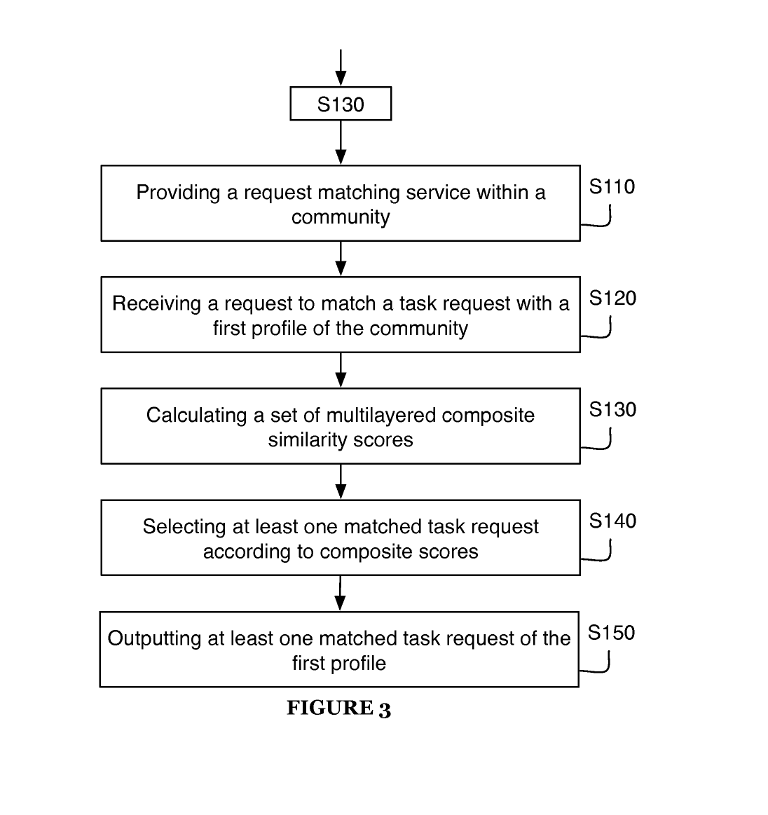

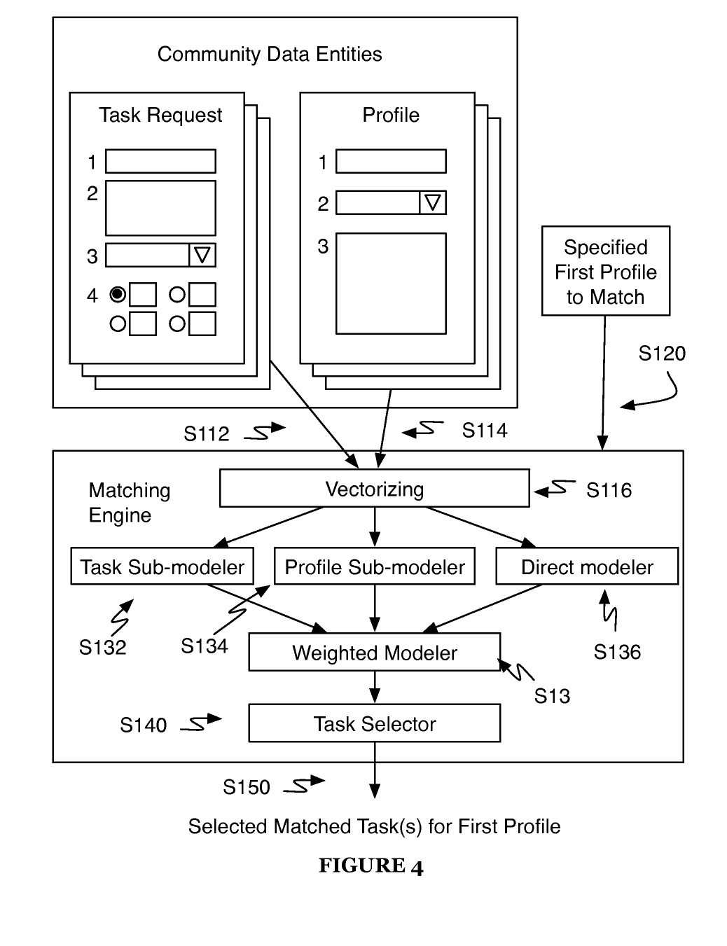

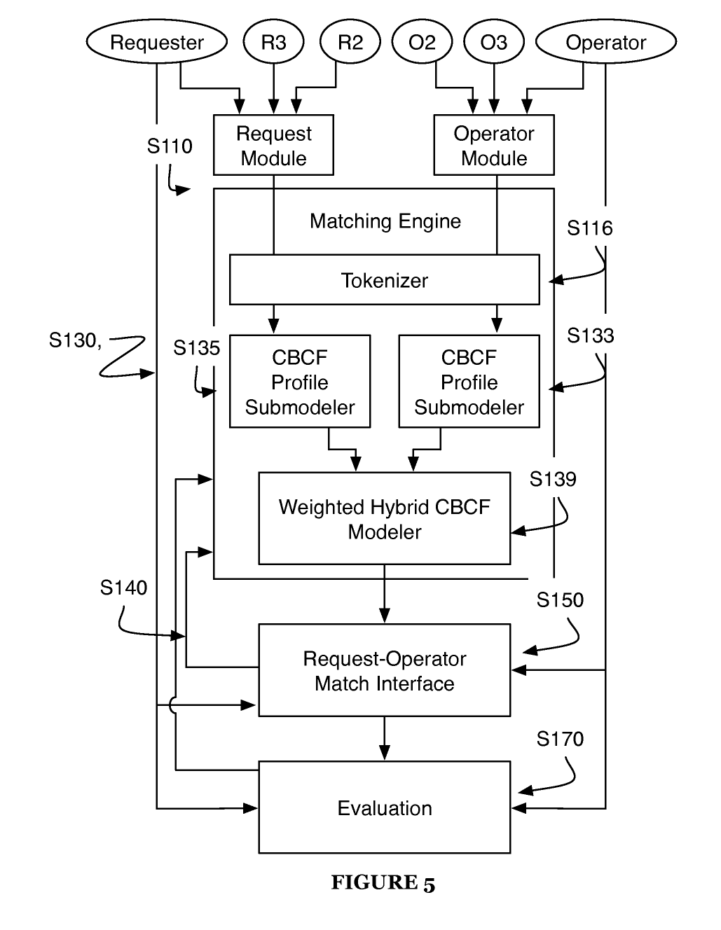

As shown in FIG. 3, a method for matching a profile to a sparsely defined request of a preferred embodiment may include providing a request matching service within a community S110, receiving a request to match a task request with a first profile of the community S120, calculating a set of multi-layered composite similarity scores S130, selecting at least one matched task request according to composite scores S140, and outputting at least one matched task request of the first profile S150. As shown in FIG. 4, calculating a set of multi-layered composite similarity scores preferably includes calculating a profile vector similarity score of the first profile compared to the profiles that completed an inspected task S132 and calculating a task vector similarity score of the inspected task compared to a set of tasks interacted with by the first profile S134. The similarity scores can incorporate content-boosted, collaborative filtering (CBCF) process as shown in FIG. 5. The method functions to enable a distributed platform to perform matching of at least one sparsely defined item to another item. The first item is preferably a task, which can be a question, an interaction request by a user, or any suitable task request. After being matched, a user can complete an interaction with a task which can include submitting a response (e.g., an answer to a question), completing an outside action (e.g., writing a document, completing a graphic, performing some unit of work outside of the platform), commenting on the task or other user interactions (e.g., feedback, rating someone else's interaction), performing a social promotion of the task (e.g., sharing, liking, favoriting, and the like), or completing any suitable accountable action with the task. In one exemplary application, the method is used by non-profit organizations to submit task requests to a pool of volunteers. The volunteers are intelligently paired with tasks for which they are suitably skilled to perform and that would motivate them to complete the work. The method may be used in situations where little to no historical data is known about the request and/or the operator. A task may no longer need to be matched after completion or, similarly, the net benefit decreases for interactions after the requested interactions have been received, and so task requests typically satisfy this condition. New operators (i.e., users) also will have no to little historical data. The method may alternatively be used to match content of any suitable crowd sourced request-fulfillment application. The method can additionally be applied towards creation, modification, and management of communities. The robust handling of sparse information can be applied to generation of new communities. When starting a new community, there are few tasks and few profiles. As described below, the multi-layered composite scores can be used to compensate for lack of data of either a profile, request, or overall in a community.

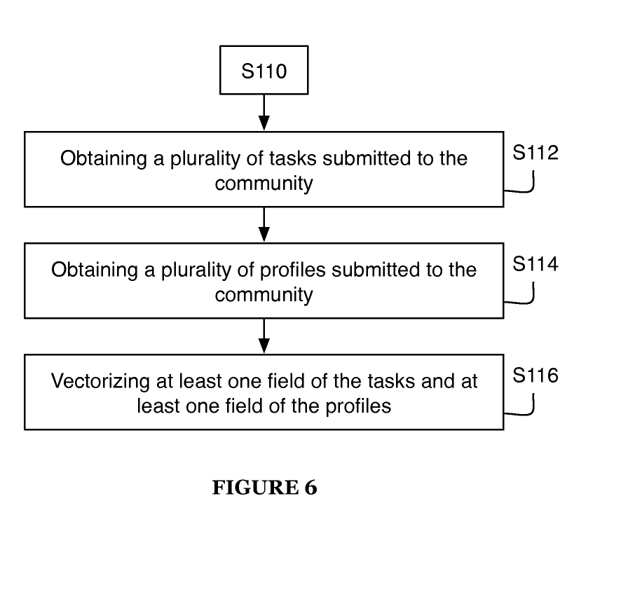

Block S110, which includes providing a request matching service within a community S110, functions to operate or run a community platform on which the method occurs. The method is preferably provided through a platform on which a community can run. In one variation, the platform can provide a system through which multiple communities can be created. Alternatively, the method can be a tool or service used within a community. The community is preferably targeted at connecting task requests with suitable operators (i.e., users associated with a profile). The community will preferably include multiple task requests and multiple profiles, but the community may start with no requests and no profiles. The community is preferably a web platform accessible through a browser connected to the internet or a local network, but the community can alternatively be a native application or use any suitable interface. Providing a request matching service preferably includes obtaining a plurality of tasks submitted to the community S112 obtaining a plurality of profiles submitted to the community S114, and vectorizing (and/or tokenizing) at least one field of task and at least one field of a profile S116, which function to process input data of the platform as shown in FIG. 6.

Step S112, which includes obtaining a plurality of profiles submitted to the community, functions to receive a request data entity that requires fulfillment. The platform preferably includes a plurality of requests requiring fulfillment at any particular time. A request is preferably submitted through a request module as described above. A user uses an interface of the community to submit the request. The requests can submitted through an administrator of the community from a user of the community (e.g. a profile operator), collected from anonymous submissions, or from any suitable party. The request data entity can additionally be edited or updated at any suitable time. The request preferably includes a number of field parameters that can include a request description, description of a requester (i.e., who is making the request), description of corresponding skills to complete a request, and/or causes or reasons of the request, but may additionally or alternatively include title description, a geographic location, a category label, topic tags, time estimate, and/or any suitable description of the request. The fields can be any suitable type of form field such as a text field, a selection option, a numerical value, multiple choice selection, or any suitable type of form field input.

Step S114, which includes obtaining a plurality of operator profiles, functions to establish content descriptions of a plurality of entities to match with the request. The operator profiles are preferably obtained through an operator module as described above, but may be obtained in any suitable manner. The operator profile preferably includes a parameter for skills and a parameter for interests, but may additionally or alternatively include parameters for a personal summary, past jobs, geographic location, and/or any suitable content to associate with the operator. An operator profile is preferably obtained during an account creation process, but may alternatively be created or updated at any suitable time. The parameters are preferably user created textual descriptors but may additionally or alternatively include any suitable type of field types. Additionally, data and information may be pulled from related social media profiles and/or associated content. Social media feeds, outside content ratings, social promotions (e.g., likes or dislikes), content sharing, and/or any outside information may be incorporated into the operator profile and used finding a match.

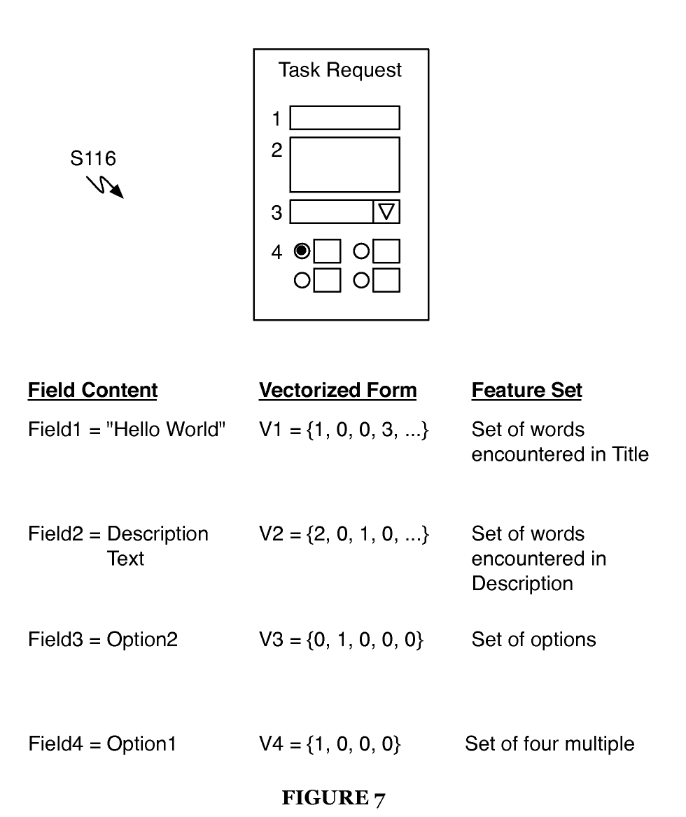

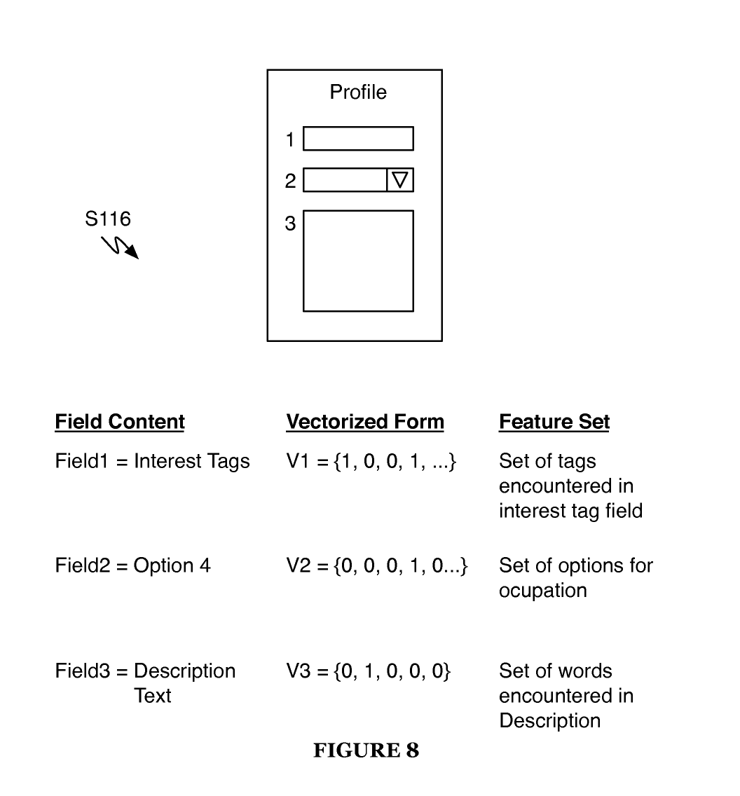

Block S116, which includes vectorizing at least one field of task and at least one field of a profile, functions to convert field parameters to representations suitable for calculating similarity. Each parameter field is preferably tokenized and converted into a vector. The vector is preferably defined within a feature set of the field as shown in FIGS. 7 and 8. The feature field can be continuously updated according to new extracted feature items during the vectorization process. In one exemplary implementation, an operator profile is preferably converted to a skills vector and an interest vector. In a freeform text field of a profile or a request, the content can be reduced to a natural language component. For example, word frequency can be counted within the text field, and a vector with indices for each word used within the community is generated with a value indicating the number of occurrences in that field. In a multiple-choice field, the vector can include indexes for each multiple choice option with a binary indicator of which is selected. A request data entity is preferably converted to a request description vector, requester description vector, related skills vector, and interests vector. Additionally multiple fields of a profile or request can be vectorized into a single vector. The vectors are preferably used in calculating a cosine-based similarity of operator profiles or requests, but any suitable similarity comparison can be used. The tokenizing of a freeform parameter may use any suitable natural language processing technique to extract a valuable signal to compare to other entities with the same freeform parameter. As one possible solution, vectorizing the request data entity and the operator profiles may include low-level text processing that groups strings as identical if their string distance is less than a minimum distance apart. One technique to avoid a noisy vector signal would be to reduce the number of considered features such as by using singular value decomposition (SVD). Any suitable vectorization process may alternatively be used.

Block S120, which includes receiving a request to match a task request with a first profile of the community functions to initialize a matching query. The match request is preferably made with the objective of identifying at least one task request that is selected as a recommended task for the operator associated with the profile. The match request is preferably made or initialized by the operator of the profile. For instance, a dashboard for the profile can always display a list of recommended tasks, and accessing the dashboard initiates outputting a recommended task. In alternative implementation, the query may include specifying a username or identifier of a profile, which should be used as the targeted first profile. As described below, alternative approaches can provide matching functionality to identify one or more profiles for a given task.

Block S130, which includes calculating a set of multi-layered composite similarity scores, functions to calculate a measure of preference of matching a task and a profile. When matching a given profile to a task from a set of possible tasks, each considered task receives a composite score. The composite score preferably incorporates multiple similarity sub-scores based on different properties of tasks and/or profiles.

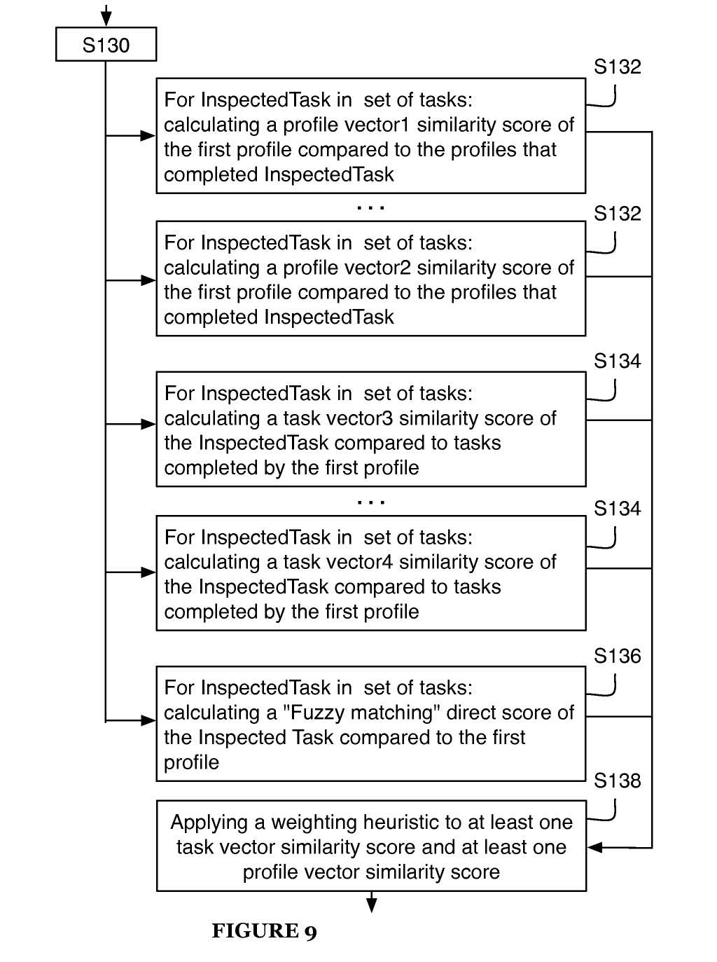

As shown in FIG. 9, calculating a set of multi-layered composite similarity scores can include for each inspected task request from the plurality of task requests of the first community, calculating at least one task vector similarity score of the inspected task compared with a set of tasks with completed interactions by the first profile S132; for each inspected task request from a plurality of task requests of the first community, calculating at least one profile vector similarity score of the first profile compared to the profiles that completed the inspected task S134; and calculating a composite score for each inspected task request from plurality of task requests of the first community, wherein calculating the composite score of a task request comprises applying a weighting heuristic to at least one task vector similarity score and at least one profile vector similarity score S138. Additionally the method can include for each inspected task request, calculating a basic similarity score of the first profile compared to the inspected task request S136. Furthermore, S132, S134, and S136 can be performed multiple times for various vectors or fields. In the preferred implementation, each type of sub-score is calculated for a considered task request. The method preferably comprises iterating through a plurality of considered tasks. The considered tasks can be the full set of tasks in the community, a set of the most recent tasks, a set of outstanding task requests (which have not been completed), or any suitable collection of tasks.

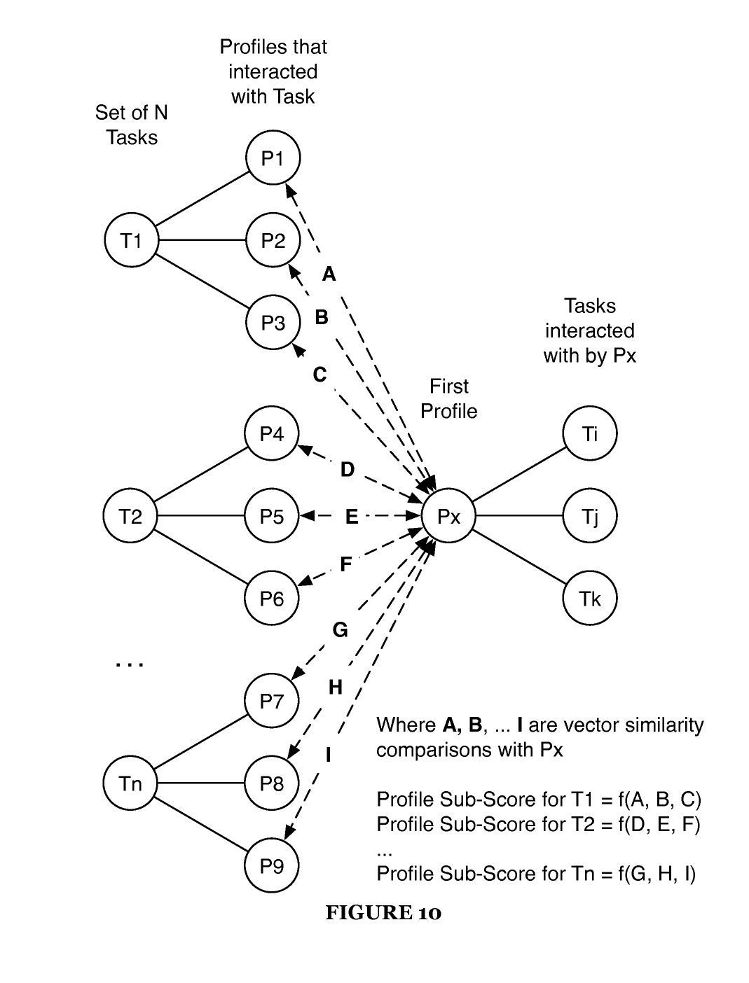

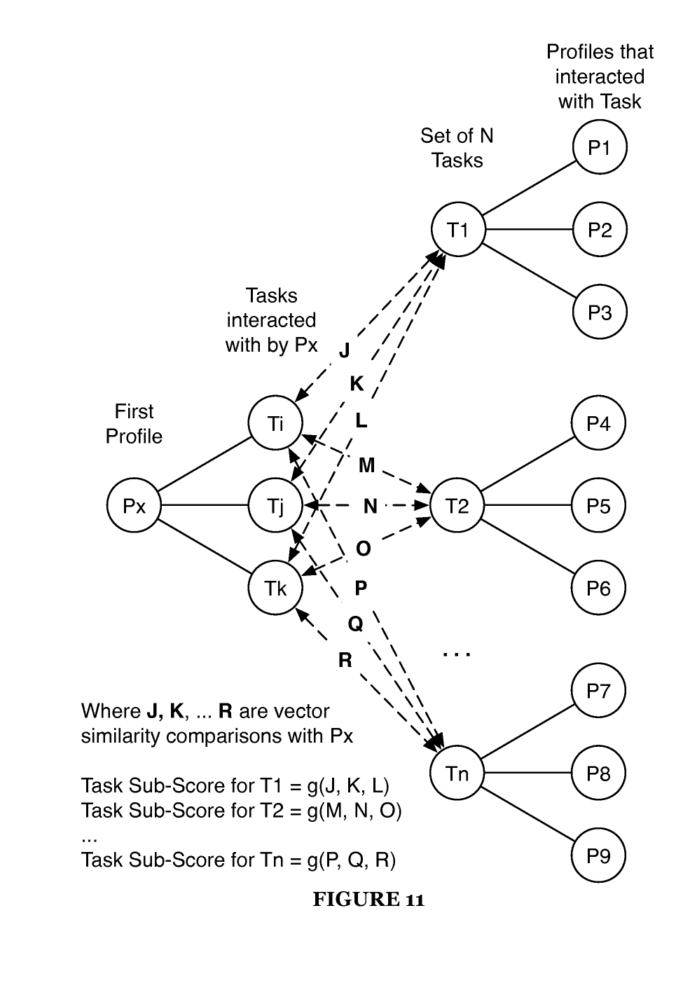

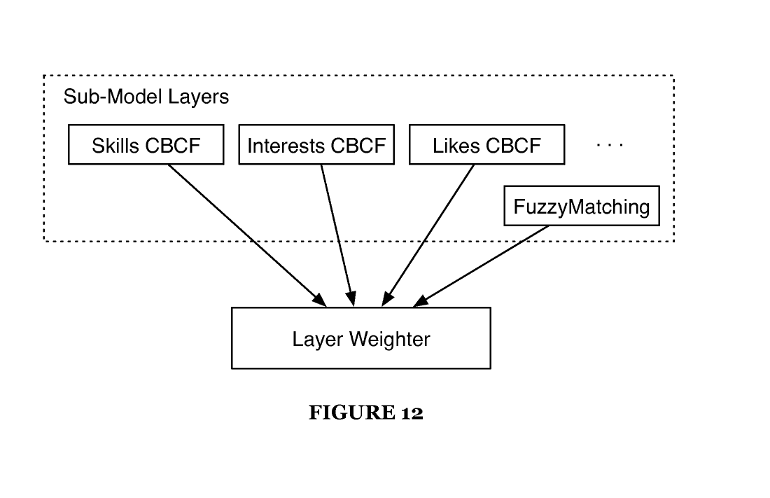

A profile similarity score is a measure of similarity of the first profile compared to the profiles that completed the task in question as shown in FIG. 10. The profile similarity score can be beneficial when the interaction history of a given task is sufficient to provide some basis for judging if similar operators have completed a task. A task similarity score is a measure of similarity of the task in question with the set of tasks requests that a profile has interacted with (i.e., completed some form of interaction), as shown in FIGURE ii. The task similarity score can be beneficial when the interaction history of the first profile is sufficient to provide some basis for judging the tasks the operator has previously enjoyed. A task request may never have received any interactions and the task similarity score can contribute to matching the task to the profile. The sub-scores can include multiple task similarity scores for different task information fields, and can similarly include multiple profile similarity scores for different profile fields. The number of task or profile similarity score types is preferably dependent on the vectors available from block S116 as shown in FIG. 12. For example, each considered task request can have a task similarity score for the description field, a task similarity score for a tag field, a profile similarity score for a skill set field, and a profile similarity score for an interest field. Additionally depending on the field the vector can be normalized. Accordingly, the Block S130 can include normalizing vector of a data entity (e.g., a profile or a task) and determining the similarity score of normalized rating between the first entity and other entity.

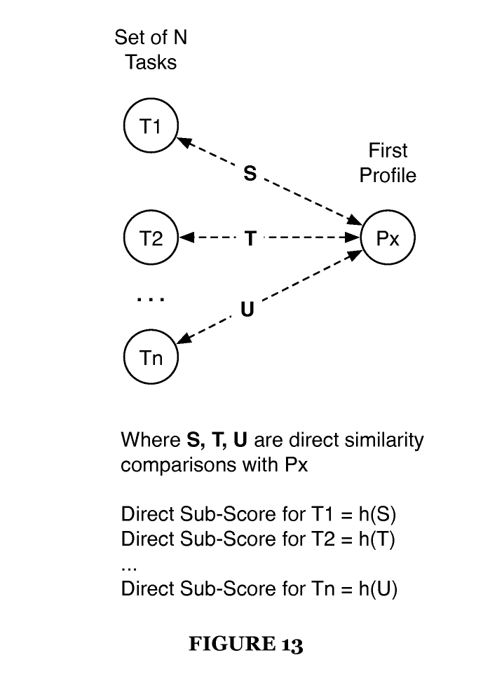

A basic direct similarity score is a measure of similarity applied directly between the inspected task and the first profile as shown in FIG. 13. For example, the user interests can be compared directly to the description field of a task request. The direct similarity score can be described as a direct comparison and can be based on fuzzy search matching and other suitable similarity heuristics for comparing two documents.

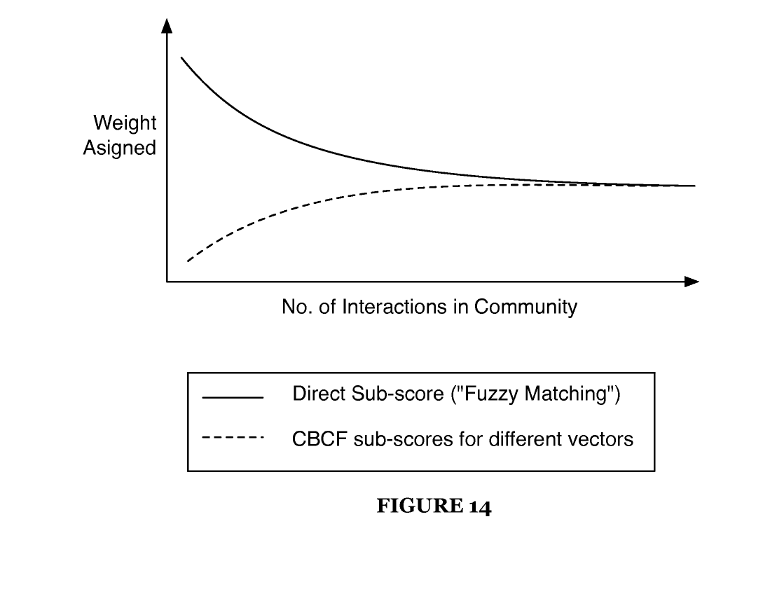

The sub-scores are used in combination to create a composite score. The composite score is preferably a weighted combination of the sub-scores. In one exemplary scenario the weighted composite score can be calculated as w₁*TaskScore₁+w₂*TaskScore₂+w₃*ProfileScore₁+w₃*PRofileScore₂+w₄*DirectScore=CompositeScore(Task1). Further, the matching engine can apply normalization and other considerations into the generation of a composite score. Calculating a set of multi-layered composite similarity scores can additionally include modifying the weighting heuristic applied to the composite score, which functions to augment the weights during different iterations. In addition to weights additional modifications to calculating a composite score can additionally be made. The weights can be used to facilitate providing improved matches depending on the stage of the community. When a community has few users the task sub-score may be weighted more strongly. When a community has numerous profiles but few tasks, the profile sub-score can be weighted more strongly. Different weight profiles can be invoked or applied depending on the stage of the community. In one variation, a continuous or discrete set of weight profiles can be applied depending on the stage of the community as shown in FIG. 14. The stage of the community can be based on number of interactions within the community, the number of tasks or profiles, the age of the community or any suitable property. Additionally, the method can include receiving a preference of community matching and modifying the weighting according to the received preference matching. A community can include a matching style preference setting or settings. Different weights can have different matching characteristics. For example, a weight profile can impact quality of interactions by a profile, speed of interactions by a profile, enjoyment from interacting with a task, or any suitable property. Weights can additionally or alternatively be learned over time.

The processing preferably includes at least one machine learning algorithm. The processing of the request and the plurality of operator profiles preferably consists of the content-boosted, collaborative filtering (CBCF) process but may additionally or alternatively use any suitable process. Task requests may be unique, independent, and transitory. A machine learning algorithm that can extract patterns from content may address the aforementioned issues of task requests. Additionally or alternatively, machine learning processes that leverage historical data during the life of a task request may be used. For example feedback for the initial response of an operator when presented a task request, or task request response candidates (attempts at satisfying the request) may additionally provide an avenue for machine learning feedback. The processing of the request and operator profiles is preferably automatically employed to transform request and operator data into request-operator matches.

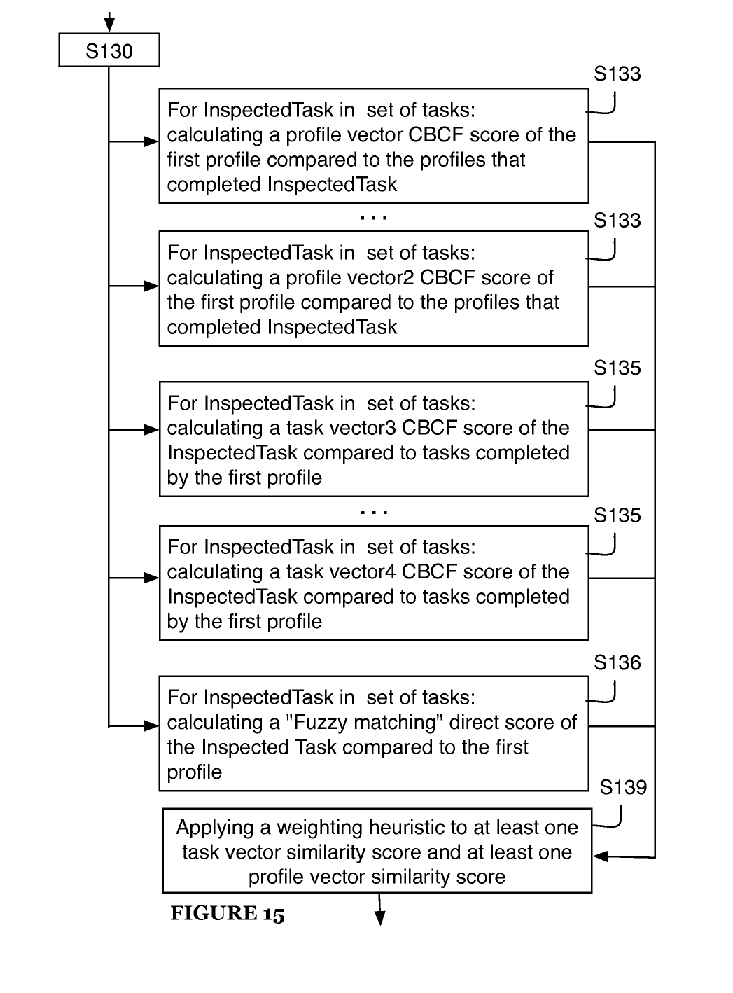

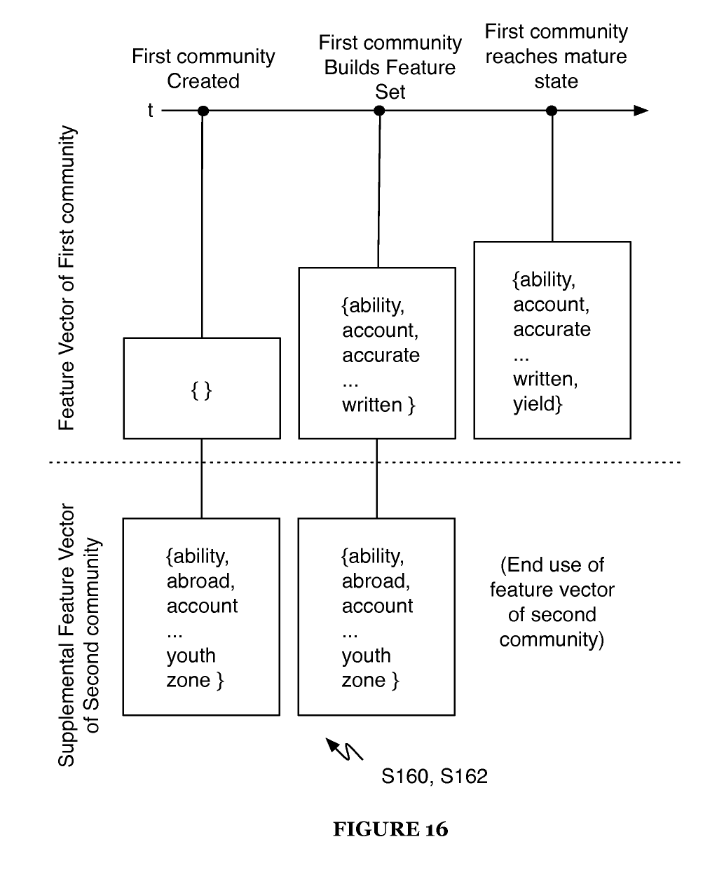

In one preferred embodiment shown in FIG. 15, Block S130 (and corresponding steps of S132, S134, S136, and S138) can include performing a content-boosted, collaborative filtering (CBCF) process, which functions to leverage natural language processing to use content of an entity to intelligently identify pairings. The CBCF process of a preferred embodiment preferably includes creating a CBCF sub-model for a task S135; creating a CBCF sub-model for a profile S133; and creating a weighted CBCF model for request and operator profiles S139. The CBCD process preferably derives predictions substantially from content. The CBCF process is composed into parallelizable problems. Parallelized computations of the CBCF process are preferably distributed across a plurality of computing devices. The computing devices are preferably part of a distributed computing infrastructure. Data, intermediate results, calculations (e.g., similarity measures and vector representations) may be stored in a database. Distributing the parallelized computations functions to enable fast, indexed, and distributed access.

Step S133, which includes creating a CBCF sub-model for a task, functions to predict a rating using direct content similarities of requests. Block S133 is a preferably a more specific implementation of S132. The CBCF sub-model for a task (i.e., a CPCF task similarity score) is preferably used to score each considered task. A task is typically unique from any previously created task. The task may additionally use freeform descriptions to capture the nature of the task. Thus, a new task can have the unique problem that there is no historical data for that particular task data entity that may be used. The content-boosted machine learning process preferably leverages the content of the task and tasks completed by a profile. In doing so a score or rating may be generated for the similarity of the request to other requests according to the content of the requests. The prediction for a given request (e.g., task tₖ) for a user (e.g., operator pᵢ) may be calculated as shown in equation 1:

$$pred ( {t}_{k} , {p}_{i} ) = {t}_{ibase} + \frac{{\sum }_{{t}_{l} ∈ T ; k \neq l ; {r}_{{t}_{k}} , {p}_{i} ∈ R} sim ( {\vec{t}}_{k} , {\vec{t}}_{l} ) \times ( {r}_{{t}_{k} , {p}_{i}} - {\overline{r}}_{{t}_{k}} )}{{\sum }_{{t}_{l} ∈ T ; k \neq l ; {r}_{{t}_{k}} , {p}_{i} ∈ R} sim ( {\vec{t}}_{k} , {\vec{t}}_{l} )} \qquad ( 1 )$$

The similarity function may be calculated as shown in equation 2:

$$sim ( {t}_{k} , {t}_{l} ) = \frac{1}{W} {\sum }_{w} \frac{{\vec{t}}_{{k}_{w}} \cdot {\vec{t}}_{{l}_{w}}}{\vert {\vec{t}}_{{k}_{w}} \vert \vert {\vec{t}}_{{l}_{w}} \vert} \qquad ( 2 )$$

Step S135, which includes creating a CBCF sub-model for a profile, functions to predict a rating using direct content similarities of operator profiles. Block S135 is a preferably a more specific implementation of S134. The CBCF sub-model for an operator (i.e., a CPCF profile similarity score) is preferably used to score each considered task according similarity of the first profile to profiles that completed an interaction with the task. The CBCF sub-model for operator profiles leverages content similarities of profiles of users. Historical data may additionally be factored into the rating prediction, but for a new profile, a score for profile similarity of profiles can be generated based on direct content of the profile as opposed to just implicit content such as historical data on ratings. For example, a new profile may have a number of profiles ranked as highly similar despite the fact that the profile has had no interactions with requests or other profiles. The prediction for a given operator profile (e.g., operator pᵢ) for a given request (e.g., request tₖ) may be calculated as shown in equation 3.

$$pred ( {p}_{i} , {t}_{k} ) = {p}_{ibase} + \frac{{\sum }_{{t}_{l} ∈ T ; i \neq j ; {r}_{{p}_{j}} , {t}_{i} ∈ R} sim ( {\vec{p}}_{i} , {\vec{p}}_{j} ) \times ( {r}_{{p}_{j} , {t}_{k}} - {\overline{r}}_{{p}_{j}} )}{{\sum }_{{t}_{l} ∈ P ; i \neq j ; {r}_{{p}_{j}} , {t}_{k} ∈ R} sim ( {\vec{p}}_{i} , {\vec{p}}_{j} )} \qquad ( 3 )$$

The similarity function may be calculated in a similar manner as for the request similarity function and as shown in equation 4:

$$sim ( {p}_{i} , {p}_{j} ) = \frac{1}{V} {\sum }_{v} \frac{{\vec{p}}_{{i}_{v}} \cdot {\vec{p}}_{{j}_{v}}}{\vert {\vec{p}}_{{i}_{v}} \vert \vert {\vec{p}}_{{j}_{v}} \vert} \qquad ( 4 )$$

Step S139, which includes creating a weighted CBCF model for request and profiles, functions to complete a hybrid multi-layered CBCF similarity calculation. Block S139 is a preferably a more specific implementation of S138. The weighted CBCF model preferably generates a composite score for each inspected task. The weighted CBCF model preferably takes into accounts both types of content requests and operator profiles. The weights may be tuned or determined through any suitable manner. The combined prediction can be calculated as shown in equation 5:

$$combinedPred ( {p}_{i} , {t}_{k} ) = \frac{\begin{matrix}pred ( {p}_{i} , {t}_{k} ) \times {\sum }_{{p}_{j} ∈ P ; i \neq j ; {r}_{{p}_{j}} , {t}_{k} ∈ R} 1 + \\ pred ( {t}_{k} , {p}_{i} ) \times {\sum }_{{t}_{l} ∈ T ; k \neq l ; {r}_{{i}_{k }} , {p}_{i} ∈ R} 1\end{matrix}}{{\sum }_{{p}_{j} ∈ P ; i \neq j ; {r}_{{p}_{j}} , {t}_{k} ∈ R} 1 + {\sum }_{{t}_{l} ∈ T ; k \neq l ; {r}_{{t}_{k}} , {p}_{i} ∈ R} 1} \qquad ( 5 )$$

Block S140, which includes selecting at least one matched task request according to composite scores, functions to identify suitable tasks to present or otherwise match to the first profile. After completion of block S130 a set of tasks have composite scores. The composite scores with the scores indicating the greatest similarity can be selected. In one variation, the highest composite score (or similarly the one with a value indicating greatest match) may be the only task selected as a matched task request. In another variation, sub-set of tasks can be selected that have the highest composite scores (e.g., top ten tasks). Selecting matched tasks can additionally factor in additional considerations such as number of interactions of the tasks, priority of the task, age of the task, profile settings, and/or any suitable property of a task or profile. For example, a first task may have received the highest composite score but has already received interactions from multiple profiles, and a second task has a high composite score (but lower than the first task) and has yet to be interacted with by a user. The second task may be selected according to a community setting to de-prioritize tasks with multiple previous interactions.

Block S150, which includes outputting at least one matched task request of the first profile S150. Step S150, which includes outputting task-profile matches, functions to deliver results of matching task requests to operator profiles. In a preferred embodiment, the output is a user interface with a list of task options that is presented to an operator. The list of task options are preferably the most likely task requests that the operator will find engaging and will be capable of performing based on the profile of the operator (e.g., skill set of the operator). In another variation, only the task match with the highest ranking is presented to the operator, and the operator is not given an option of selecting from a plurality of requests. The tasks may alternatively be presented to the operator in any suitable manner. A user interface presented to an operator is preferably configured to receive a task request response. The response user interface may be an interface that facilitates completion of the request such as by displaying a survey form, submitting input form fields, uploading a file, interacting with an application or widget to complete the request, and/or any suitable interface to facilitate or acknowledge an attempt to respond to a request. The method may additionally include refining output through response to the request-operator matches S152. When an operator is presented with various options, the actions of the operator may be used to dynamically update the matches or refine subsequent request-operator matching. For example, when an operator clicks on the title of a request in a list of requests, the request is preferably indicated as more appropriate compared to a request that had been presented but not viewed in detail. If a user attempts to complete a request, that request is preferably indicated as more appropriate compared to requests viewed but with no response attempt. In other words, interactions with a task request can be used in feedback to calculating a composite similarity score. Such interactions can be used to train improved weight profiles or augment similarity calculations in any suitable manner. At least the tasks that receive an interaction from an operator are recorded so that a mapping of profiles that have interacted with or completed a request and a mapping of tasks that a specific profile has interacted with or completed can be used when calculating a profile similarity score or a task similarity score respectively.

Additionally, the method can include supplementing calculating a set of multi-layered composite similarity scores with resources of a second community S160, which functions to apply matching resources of a second community in a first community. A community can be distinct from an outside second community implementing a similar method. A community preferably includes its own set of feature sets and/or can use a customized weighting profile. The set of feature sets, which is preferably used during calculating sub-scores) are preferably refined overtime during use of a community. When a new community is started, the lack of historical information can result in a limited set of feature sets. Development of the set of feature sets can be skewed or biased according to initial tasks or profiles when initially starting the community.

In a first variation, block S160 can include supplementing a set of feature sets of the first community with a second set of feature sets of a second community S162. The set of feature sets can be initially used, and as tasks and profiles are vectorized, the set of feature sets of the first community can be constructed and used in parallel with the set of the second community. For example, one feature set can be a dictionary of words identified within a description field of a task. When starting out this dictionary in the first community may not have any words. However, vectorizing a task will use the dictionary of words of the second community. When a new vector element is encountered, the vector element can be added to the feature set of the first community. When the first community has reached a mature state, the set of feature sets of the second community can be retired, deprecated, or otherwise removed from use in the first community. A mature state can be detected through the age of the community, the number of interactions in the first community, steadying of the rate of changing the feature sets of the first community, or at any suitable time where the first community is ready for operating independently. Additionally or alternatively the feature set of the first community can be merged into another community. For example, the first feature set can be merged with the feature set of the second community in the case where a union of the first and second community is desired. Feature sets can be used from any suitable number of communities. Additionally individual feature sets can be borrow from specific feature sets of another community. For example, a first feature set of a first field is borrowed from a first outside community and a second feature set of a second field is borrowed from a second outside community. When creating a new community, an option may exist where the user can specify similar communities, the specified communities are preferably used to seed an initial set of feature sets. For example, a user can be asked if the new community relates to any of the topics including: technical, finance, marketing, sales, charity, or customer support. A set of feature sets can be used depending on which of these topics is selected.

In a second variation, block S160 can include applying weight profiles of a second community to the first community S164. Block S164 functions to use weight profiles of a second community during at least one stage of the first community. Preferably, the first community can use a sequence of weight profiles from different stages in the development of the second community. Different weight profiles can be appropriate for different stages of a community. For example, the weight profile used in Block S 138 is preferably different for a new community compared to a community that has reached a critical mass of interactions, tasks, profiles, or some suitable metric.

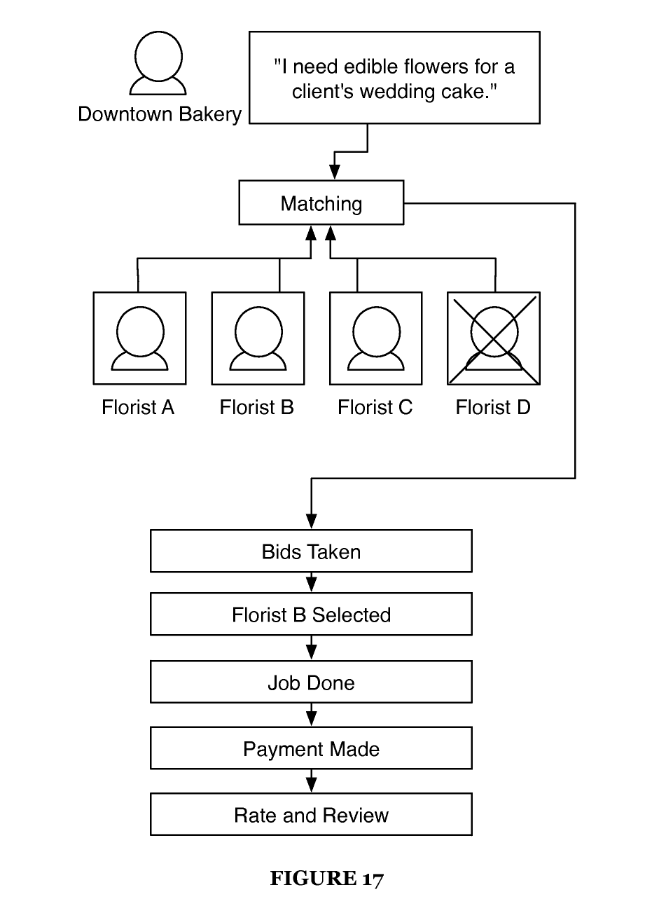

Additionally or alternatively, the outputted request-operator matches may be configured for viewing and reaction by a requesting entity. A request-operator match interface for a requester may enable a requesting entity to adjust or update the request to more appropriately target a desired operator. The request-operator match preferably presents a list of operators that have been highly ranked as appropriate candidates for fulfilling the request. As shown FIG. 17, in an exemplary use-case, a baker may submit a request for a florist that sells edible flowers. Since edible flowers may be a niche item, it's not necessarily something that a florist would list explicitly as something he or she offers for sale. A list of user and business profiles is preferably displayed highlighting operators that the matching engine identified as likely to sell edible flowers based on the similarity of those florists to other florists who have sold edible flowers in the past. The florists may be identified from similar profiles and/or interests determined from a social media stream. These florists would then be invited to submit a proposal for the bakers business. Upon expressing interest (submitting a proposal) the baker may then review bids and select one. If the matched operators do not satisfy the requester, the requester may modify the request parameters to request a re-match. Such an interface for a requesting entity may be a preliminary step prior to publishing a request to operators. Additionally, any modifications by a requester may be considered in calculating subsequent matches.

Additionally, a method of a preferred embodiment may include collecting request responses from at least one operator S170, which functions to retrieve work completed by an operator in an attempt to contribute at least in part to the request. A plurality of responses to a request may be received. This may enable a request to be fulfilled multiple times. Alternatively, this may allow several proposed responses to be received and then at least one response to be accepted from a pool of received responses. As discussed above an operator can preferably select a request, perform the specified task or work, and then submit response to the request. The response is typically the assets desired by the request, but may alternatively be references to work or tasks completed. For example, an operator may submit proof of completing three hours of labor towards a particular request. A requester can preferably review and rate responses submitted by an operator. Responses may be accepted, not accepted, rated, ranked, scored, accounted for, and/or receive any suitable judgment or evaluation. The response evaluation may be captured and used in subsequent matching processes either in sub-model CBCF processing or any suitable portion of the matching process. In a similar manner, an operator may evaluate a request such as by evaluating the appropriateness of the skills required (e.g., did the operator feel they had the appropriate skill set) or the level of satisfaction or reward they received from completing the request (e.g., level of enjoyment in completing a response). Such request evaluations similarly may be factored into request-operator match processing.

The above method can similarly be applied to the situation where the query specifies a first task request and one or more matched profiles are identified that are recommended for the first task. The method preferably operates in substantially similar manner except the roles of the profiles and tasks are reversed. The task-oriented method preferably includes obtaining a plurality of profiles submitted to the first community; vectorizing at least one field of obtained tasks and at least one field of obtained profiles; providing an interface through which a profile can complete interactions with a task and recording a mapping between a task and a profile when a profile completes an interaction with a task; receiving a request to match at least one profile to a first task; generating a set of sub-scores, wherein each sub-score directly corresponds to one profile of the plurality of profiles; a first set of sub-scores includes for each profile calculating a similarity score of the first task to tasks completed by the profile in question; a second set of sub-scores includes for each profile calculating a similarity score of the profiles that interacted with the first task to the profile in question; a third set of sub-scores where for each profile calculating a direct similarity score of the first task compared to the profile in question; weighing the sets of sub-scores to generate a composite score; calculating a composite score for each inspected profile from plurality of profiles of the first community, wherein calculating the composite score of a profile comprises applying a weighting heuristic to at least one task similarity score and at least one profile similarity score; selecting at least one matched profile according to the composite scores of the plurality of profiles; and outputting the at least one matched profile of the first task. Additional and alternative variations of the above profile-directed method can similarly be applied in an appropriate manner. The method can additionally be applied to situations where the task or profile entities are replaced with other suitable forms of content or data entities

An alternative embodiment preferably implements the above methods in a computer-readable medium storing computer-readable instructions. The instructions are preferably executed by computer-executable components preferably integrated with a request-operator matching platform. The computer-readable medium may be stored on any suitable computer readable media such as RAMs, ROMs, flash memory, EEPROMs, optical devices (CD or DVD), hard drives, floppy drives, or any suitable device. The computer-executable component is preferably a processor but the instructions may alternatively or additionally be executed by any suitable dedicated hardware device.

As a person skilled in the art will recognize from the previous detailed description and from the figures and claims, modifications and changes can be made to the preferred embodiments of the invention without departing from the scope of this invention defined in the following claims.

We claim:

1. A method for matching a task request to a profile of a first community, where the profiles complete interactions of a task request through the first community comprising:
vectorizing at least one field of a task request and at least one field of an operator profile for a plurality of task requests and operator profiles of the first community;
receiving a request to match a task request with a first profile of the first community;
for each inspected task request from the plurality of task requests of the first community, calculating at least one profile vector similarity score of the first profile compared to the profiles that completed the inspected task;
for each inspected task request from the plurality of task requests of the first community, calculating at least one task vector similarity score of the inspected task compared with a set of tasks with completed interactions by the first profile;
calculating a composite score for each inspected task request from the plurality of task requests of the first community, wherein calculating the composite score of a task request comprises applying a weighting heuristic to at least one task vector similarity score and at least one profile vector similarity score;
selecting at least one matched task request according to the composite scores of the plurality of task requests; and
outputting the at least one matched task request of the first profile.

2. The method of claim 1, further comprising for each inspected task request from the plurality of task requests of the first community, calculating a direct similarity score of the inspected task compared to the first profile; wherein calculating the composite score of a task request comprises applying a weighting heuristic to at least one task vector similarity score, at least one profile vector similarity score, and the direct similarity score.

3. The method of claim 2, wherein the profile vector similarity score is a content boosted collaborative filtering (CBCF) sub-score; wherein the task vector similarity score is a content boosted collaborative filtering sub-score; and wherein composite score is a weighted content boosted collaborative filtering score.

4. The method of claim 3, wherein calculating the direct similarity score comprises performing fuzzy string search of content of the profile to the inspected task request.

5. The method of claim 1, wherein the plurality of task requests includes completed task requests that have satisfied an interaction condition; and wherein selecting at least one matched task request further comprises deprioritizing a completed task request.

6. The method of claim 5, further comprising a task request satisfying an interaction condition when a profile of the community completes a goal of the task request.

7. The method of claim 1, wherein calculating at least one profile vector similarity score comprises calculating a first profile vector similarity score of a vector of a first profile field and calculating a second profile vector similarity score of a vector of a second profile field; and wherein calculating at least one task vector similarity score comprises calculating a first task vector similarity score of a vector of a first task field and calculating a second task vector similarity score of a vector of a second task field.

8. The method of claim 1, further comprising modifying the weighting heuristic of the first community at a first time instance from a prior time instance.

9. The method of claim 8, further comprising receiving a preference of community matching; and further comprising modifying the weighting according to the received preference matching.

10. The method of claim 8, wherein modifying the weighting heuristic of the first community comprises when calculating the composite score of a task request, modifying weight values according to a schedule based on lifetime of the community.

11. The method of claim 10, wherein modifying weight values according to a schedule based on lifetime of the community comprises modifying weights according to a schedule based on number of interactions during lifetime of the community.

12. The method of claim 1, wherein vectorizing at least one field of a task request and at least one field of an operator profile further comprises vectorizing at least one field of a task request according to a first feature set and vectorizing at least one field of an operator profile according to a second feature set;

13. The method of claim 12, further comprising supplementing the first feature set with a third feature set of a second community; and supplementing the second feature set with a fourth feature set of the second community.

14. The method of claim 13, further comprising selecting the second community according to type of community of the first community and type of community of the second community.

15. The method of claim 13, further comprising after the first community satisfies a mature state terminating use of the third feature set and the fourth feature set.

16. The method of claim 12, further comprising sharing the first feature set and the second feature set with a second community.

17. A method comprising:
obtaining a plurality of tasks submitted to a first community;
obtaining a plurality of profiles submitted to the first community;
vectorizing at least one field of obtained tasks and at least one field of obtained profiles;
providing an interface through which a profile can complete interactions with a task and recording a mapping between a task and a profile when profile completes an interaction with a task;
receiving a request to match at least one task to a first profile of the plurality of profiles;
generating a set of sub-scores for each inspected task of the plurality of tasks,
for at least one sub-score of the set of sub-scores calculating a profile similarity score of a first vector of the first profile to first vectors of profiles that are mapped to the inspected task;
for at least one sub-score of the set of sub-scores, calculating a task similarity score for the similarity between the inspected task to each task mapped to the first profile.
for at least one sub-score of the set of sub-scores, calculating similarity score for each inspected task compared to the first profile;
for each inspected task, calculating a composite score from the set of sub-scores of a corresponding inspected task, wherein calculating the composite score comprises applying a weighting heuristic to at least one task similarity score and at least one profile similarity score;
selecting at least one matched task request according to the composite scores of the plurality of tasks; and
outputting the at least one matched task request of the first profile.

18. The method of claim 17, wherein the profile similarity score is a content boosted collaborative filtering (CBCF) sub-score; wherein the task similarity score is a content boosted collaborative filtering sub-score; and wherein composite score is a weighted content boosted collaborative filtering score.

19. The method of claim 17, wherein calculating at least one profile similarity score comprises calculating a first profile similarity score of a vector of a first profile field and calculating a second profile similarity score of a vector of a second profile field; and wherein calculating at least one task similarity score comprises calculating a first task similarity score of a vector of a first task field and calculating a second task similarity score of a vector of a second task field.

20. The method of claim 17, further comprising receiving community type configuration of the first community; wherein vectorizing at least one field of obtained tasks and at least one field of obtained profiles comprises vectorizing at least one field of obtained tasks and at least one field of obtained profiles according to a first set of features sets; and further comprising supplementing the first set of feature sets with a second set of feature sets of a second community.
